(19) United States
(12) Patent Application Publication
(10) Pub. No.: US 2017/0323246 A1
(43) Pub. Date: Nov. 9, 2017

(54) EVENT PREDICTION IN A SYSTEM OF CONNECTED ENTITIES

(71) Applicant: ORANGE, Paris (FR)

(72) Inventors: Benoît Suzanne, Nanterre (FR); Jérôme Galloyer, L'ile Saint Denis (FR)

(21) Appl. No.: 15/522,273

(22) PCT Filed: Oct. 16, 2015
(86) PCT No.: PCT/FR2015/052784

§ 371 Date: Apr. 26, 2017

(30) Foreign Application Priority Data
Oct. 27, 2014 (FR) 1460308

(51) Int. Cl. G06Q 10/06; G06Q 10/04

(52) U.S. Cl. CPC G06Q 10/063116; G06Q 10/04

(57) ABSTRACT

The invention relates to a method for managing a plurality of entities, comprising the following steps: reception (200) of a first event notification from a first entity indicating a first event associated with a first instant; selection (201) of a predictive model applicable to the first event; deduction (202) of a future event associated with a second instant following the first instant, by application of the predictive model determined for the first event; and display (203) of the future event in association with the second instant, on a web feed. After reception (204) of a second event notification indicating a second event associated with a third instant, the method further comprises the following steps: verification (205) that the second event is an event impacting the future event; and in the affirmative, updating (206) of the future event according to the second event; and display (207) of the updated future event on the web feed.

The present invention relates to the field of managing a plurality of communicating entities, and in particular of managing connected objects.

The invention advantageously applies to a network of connected objects, such as a private network of a user.

“Connected object” is understood to mean any object able to implement given actions and further having a communication interface for sharing information over a network. No restrictions are placed on the communication interface concerned. In the following, the example of objects connected to a wireless network through a Wi-Fi interface is considered for purely illustrative purposes.

Neither are any restrictions placed on the actions implemented by the connected objects: a motion sensor detecting motion, a temperature sensor measuring the temperature of a room in which it is located, a humidity sensor measuring the moisture in the air of a room or the moisture in the soil in a flowerpot, etc. In addition, information may be sent to a local area network to which the connected objects have access, then sent to a remote or local server so the user can view it.

Applications allow a user to view data reported by the various connected objects. Such applications may be installed on a user terminal, such as a desktop or laptop computer, a touchscreen tablet, a smartphone, or any entity that can access the network of connected objects. The user can thus monitor events published by the various connected objects at respective given times, via a newsfeed for example.

However, the information sent by the connected objects is information captured at a given time and therefore does not enable the user to anticipate a future situation. For example, a humidity sensor placed in a plant's pot may indicate a moisture content of 45% at a given time, which does not allow the user to know whether the moisture content will fall below a critical threshold for the plant at a time when the user will be present to water the plant.

A need therefore exists for a user of a network of connected objects to be able to anticipate future situations accurately.

The present invention improves the situation.

To this end, a first aspect of the invention relates to a method for managing a plurality of entities implemented in a server, each electronic device being able to send event notifications to the server, the server storing at least one predictive model for the prediction of future events, the method comprising the following steps:
receiving a first event notification from a first entity, the first event notification indicating a first event associated with a first time;
selecting a predictive model applicable to the first event;
deducing a future event associated with a second time that is later than the first time, by applying the determined predictive model to the first event, the future event being associated with at least one event impacting the future event;
displaying the future event in association with the second time, on a newsfeed.
   Upon receiving at least a second event notification indicating a second event associated with a third time, the third time being between the first time and the second time, the method further comprises the steps of:
verifying whether the second event is an event impacting the future event;
in case of positive verification, updating the future event based on the second event;
displaying the updated future event in the newsfeed.

The entities may be connected objects which can communicate with the server. As detailed in the following. “event” is understood to mean a measurement carried out by one of the entities, a modification to a parameter requested by the user, or data from a third-party platform. “Predictive model” is understood to mean a model that, based on at least one input value representative of a quantity at time t, determines the evolution in said quantity for times subsequent to t. The invention thus allows the user to view event predictions, and not only events resulting from instantaneous measurements. In addition, the future event can be dynamically updated while taking into account all events that may impact it, which allows fully exploiting the network of connected entities, as the information acquired by one connected entity allows refining a prediction applied to measurements from another connected entity.

According to one embodiment of the invention, the newsfeed may be divided into a first section and a second section, the first section being dedicated to displaying events associated with times within a current period, and the second section being dedicated to displaying events associated with times within a future period. A third section may be dedicated to displaying events associated with times within a past period.

The display of current events, generally resulting from instantaneous measurements, is thus differentiated from the display of future events resulting from predictions, which facilitates the anticipation of future events by the user.

In addition, the current period may be updated dynamically, to enable informing the user in real time by removing expired events and updating the newsfeed (for example by moving events from the second area to the first area).

According to one embodiment, the first event is a value measured by the first entity at the first time. Such a measured value may be, for example, a temperature value, a moisture content value for the air or the soil in a flowerpot, binary data indicating presence/absence, etc.

In addition, if a first threshold value is predefined, the second time may be the moment when the measured value reaches the predefined first threshold value after applying the predictive model to the value measured at the first time.

Thus, the future event can indicate to the user that a threshold value will likely be reached at a second time. The threshold value may for example correspond to a value for which user intervention on one of the connected entities is required, and in this case, the user can advantageously anticipate this intervention due to the publishing of the future event in the newsfeed. As detailed in the following, and for illustrative purposes, the threshold value may correspond to the soil moisture content of a flowerpot below which the plant should be watered.

Additionally or alternatively, the second event may be an updated value measured by the first entity at the third time, and the future event may be updated by applying the predictive model to the updated value measured at the third time.

Such a dynamic update corrects any inaccuracies in the predictive model or allows taking into account unanticipated changes (such as changes in temperature, moisture content) or unpredictable changes (early intervention by the user).

According to one embodiment of the invention, the second event may be a value measured by a second entity at the third time or an action triggered by the second entity at the third time.

Such an embodiment allows making best use of the system of connected entities, as the information acquired or the actions implemented by an entity can be used to improve the reliability of predictions made based on measurements from another entity.

According to one embodiment of the invention, the second event is a parameter defined by a user at the third time.

Thus, the updating of a future event can be customized based on parameters defined by the user.

To this end, the second event may be the replacement by the user of the predefined first threshold value with a second threshold value, the updating of the future event may comprise determining a fourth time at which the measured value reaches the predetermined second threshold value after applying the predictive model to the value measured at the first time, and the updated future event may be displayed in association with the fourth time on the newsfeed.

It is therefore the user who sets the threshold value that seems critical to the user for a quantity measured by one of the connected entities, and the flexibility of the update process is thus improved.

According to one embodiment, the second event is a prediction made at the third time of a second future event at a fifth time, the fifth time being between the fourth time and the second time.

Thus, the predictions made for measurements from certain entities can be used to refine the predictions for measurements from other entities. Alternatively, the predictions may come from a third-party platform, for example having more refined predictive models than the server.

A second aspect of the invention relates to a computer program comprising instructions for implementing the method according to the first aspect of the invention, when these instructions are executed by a processor.

A third aspect of the invention relates to a server for managing a plurality of entities, each entity being able to send event notifications, the server comprising a unit for storing at least one predictive model for the prediction of future events, a reception interface for receiving a first event notification from a first electronic entity, the first event notification indicating a first event associated with a first time, and a processor arranged to implement the following steps:
selecting a predictive model applicable to said first event;
deducing a future event associated with a second time that is later than the first time, by applying the determined predictive model to the first event, the future event being associated with at least one event impacting the future event;
displaying the future event in association with the second time, on a newsfeed.
   Upon receipt by the reception interface of at least a second event notification indicating a second event associated with a third time, the third time being between the first time and the second time, the processor is further arranged to implement the following steps:
verifying that the second event is an event impacting the future event;
in case of positive verification, updating the future event based on the second event;
displaying the updated future event in the newsfeed.

Other features and advantages of the invention will be apparent from examining the following detailed description, and the appended drawings in which:

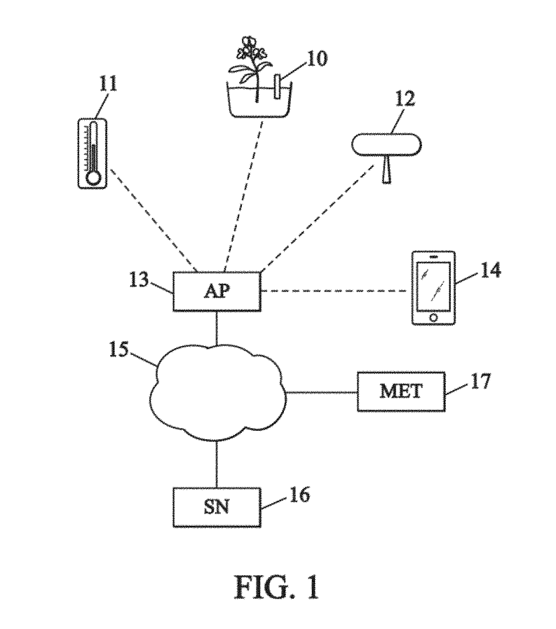

FIG. 1 illustrates a system according to an embodiment of the invention;

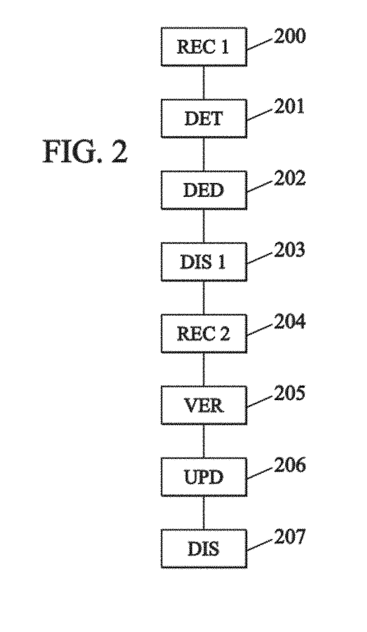

FIG. 2 is a diagram illustrating the steps of a method according to an embodiment of the invention.

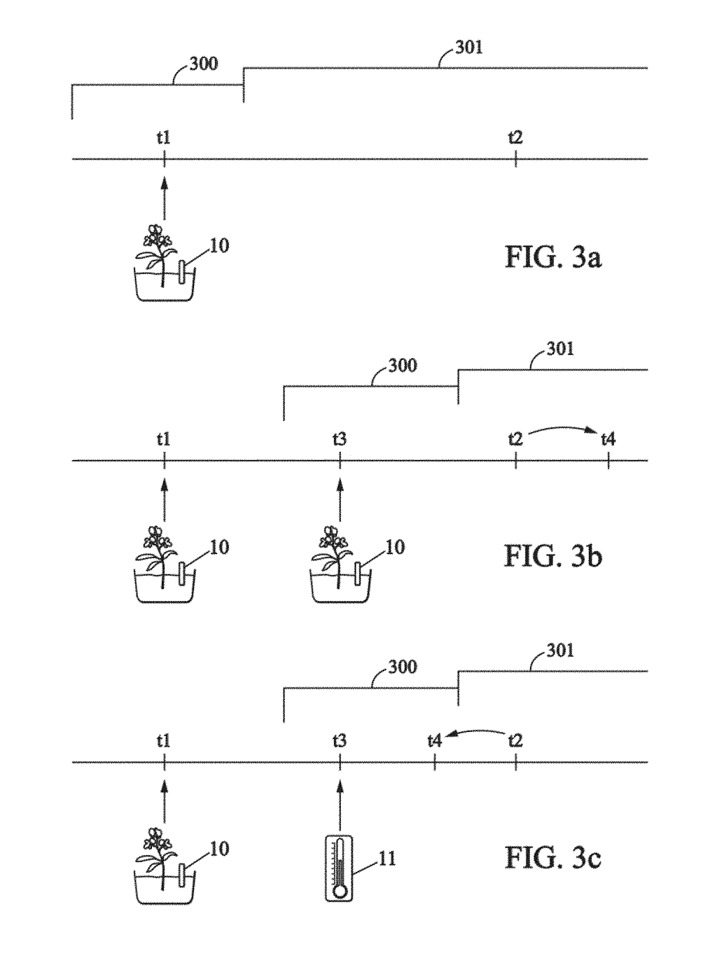

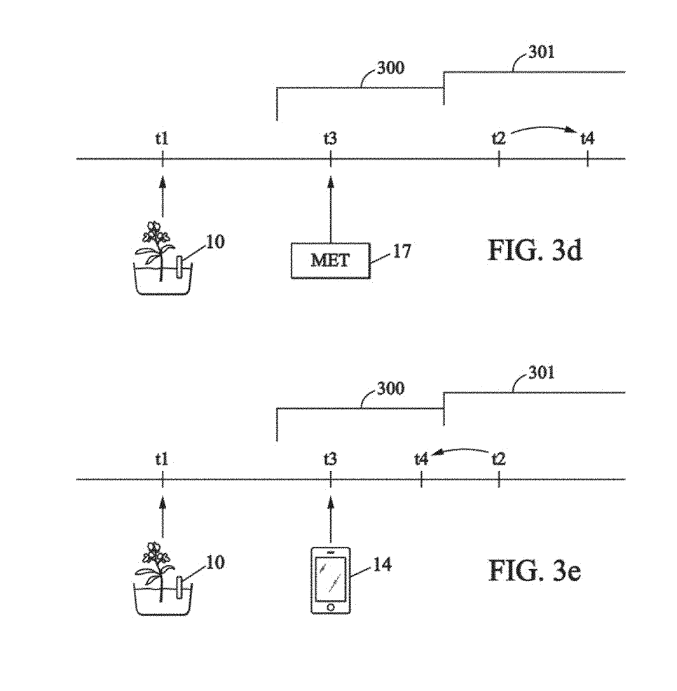

FIGS. 3a to 3e show example implementations of the method according to the invention;

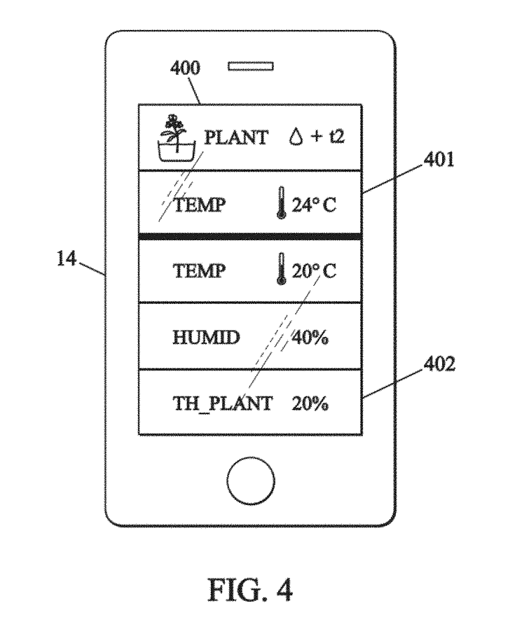

FIG. 4 illustrates the display of a newsfeed on a user terminal, according to an embodiment of the invention;

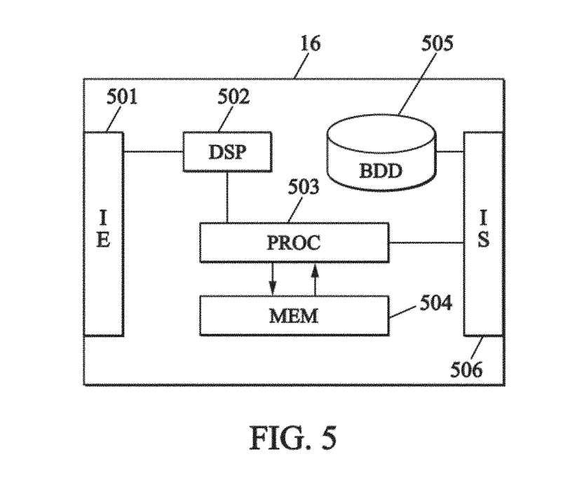

FIG. 5 shows a server according to an embodiment of the invention.

FIG. 1 illustrates a system for managing a plurality of entities 10, 11, and 12 according to one embodiment of the invention. The managed entities may be connected objects. As an illustration, the system may thus comprise a humidity sensor 10 able to measure the moisture content in a pot of a plant, a thermometer 11, and a humidity sensor 12 able to measure the moisture content of the air. By way of illustration and to simplify the following discussion, entities 10 to 12 are all considered to be located in the same room of a user.

Entities 10, 11 and 12 are connected objects and thus have respective interfaces enabling access to a network via an access point 13, which may be a Wi-Fi terminal for example. A single access point 11 has been represented. However, the invention also covers cases where the objects 10, 11 and 12 access the network via separate access points.

The access point 13 allows the entities 10 to 12 to access a network 15, such as the Internet for example, and thereby access a server 16 according to an embodiment of the invention. Alternatively, the server 16 may be integrated into the user's local area network.

As detailed in the following, each of the entities 10 to 12 is adapted to send event data to the server 12, such as instantaneous measurements for example. Using these event data, the server 12 can update a newsfeed which users can access via a terminal 14. The terminal 14 may be a portable or desktop computer, a touchscreen tablet, a phone such as a smartphone, or any other device capable of accessing the Internet 15 via the access point 13 (for example by a Wi-Fi interface), via a wired interface (Ethernet cable for example), or via a mobile access network (3G/4G for example). For this purpose, an application linked to the server 16 may be installed on the terminal 14, thus allowing access to the server 16. The terminal 14 integrates a user interface (a touchscreen for example) adapted to display the user's newsfeed.

The system may further comprise a third-party platform 17. In the following example, the platform 17 is a weather station platform able to publish weather information (measurements or predictions) on the user's newsfeed by sending event notifications to the server 16 via the Internet 15.

FIG. 2 is a diagram illustrating the steps of a method according to an embodiment of the invention.

In step 200, a first event notification is received from a first entity, the first event notification indicating a first event associated with a first time. In the example system represented in FIG. 1, we consider the first entity to be the humidity sensor 10, which measures the moisture in the pot of the plant. The first event notification can thus indicate a measurement of the soil moisture content in the pot of the plant, at a first time t1. Alternatively, the first event may be an averaged value of the soil moisture content over a given period.

According to the invention, the server 16 may store at least one predictive model for the prediction of future events. “Predictive model” is understood to mean a model that, from at least one input value representative of a quantity at time t, determines the evolution of that quantity for times subsequent to t. The following considers an example of a quantity corresponding to the soil moisture content in the pot of a plant. The server therefore stores a predictive model which determines, from the moisture content at time t, the evolution in the moisture content over a period later than t. In addition, the model may be dependent on parameters such as the temperature or moisture content of the air. If the instantaneous value of these parameters is not known, a default value may be assigned to these parameters. It is thus possible to evaluate the evolution in the soil moisture content merely by knowing the moisture content at time t. Other predictive models stored in the server 16, for example to predict the evolution of the temperature in a room from the temperature at time t (possibly refining the model by knowing the operating modes of the heaters in the room), or the moisture content of the air from the moisture content of the air at time t.

Such predictive models are known and are not explained in more detail below.

In step 201, a predictive model for the first event is selected among the predictive models stored in the server 16. In the above example, the predictive model for the soil moisture content is selected. No restrictions are placed on how the predictive model for the first event is selected. In a first example, each entity among entities 10 to 12 may be associated with the given predictive model on the server. Thus, when notification of an instantaneous temperature measurement (event) from the thermometer 11 is received, the predictive model associated with the thermometer 11 is selected by the server 16. In a second example, the server deduces the applicable predictive model from the type of event received (temperature measurement, moisture content measurement, brightness measurement, presence detection, etc.).

In step 202, a future event associated with a second time t2 is deduced by applying the selected predictive model to the first event. In the example where the first event is a measurement of the soil moisture content at time t1, the future event may be the reaching of a moisture threshold value. Thus, the predictive model foreseeing a decrease in the moisture content can predict that the soil moisture content will fall below a certain threshold value at a second time t2, the second time t2 being later than the first time t1. The threshold value may for example be a predefined value (for example 20%), or may be configured by the user, for example via the application on the terminal 14. Alternatively, the future event may be the value of the soil moisture content at a second time t2 calculated from the first time t1 (for example one day after the first time t1). The future event is then determined by extracting the value of the moisture content at the second time t2 in the predictive model applied to the soil moisture content at the first time t1.

In addition, the future event is associated with at least one event impacting the future event. As detailed above, the predictive model applied to the first event may depend on parameters that are initially set to default values. Knowledge of a current value of these parameters, however, is likely to affect the predictive model and therefore the future event. The parameters impacting a predictive model may be stored in association with the predictive model in the server 16. For example, in the case of a predictive model for the soil moisture content, the temperature and moisture content of the air can be considered as impacting the predictive model. Of course, a new measurement of the soil moisture content is also an event impacting the predictive model.

In step 203, the future event is displayed in the user's newsfeed, in association with the second time t2.

FIG. 3a shows a timing diagram illustrating the prediction of the future event after steps 200 to 203. At the first time t1, a moisture content measurement is received from the humidity sensor 100 and a future event associated with time t2 is derived by applying a predictive model to the moisture content measurement at the first time t1. In addition, a current period 300 corresponding to a time period containing a current time (in the present case, positioned at the first time t1). The current period 300 may, for example, correspond to the day of the current time. Alternatively, the current period 300 may include a period of time before the current time and a period of time after the current time (for example, the current period is a 12-hour period centered around the current time). A future period 301 includes all times after the end of the current period 300. The current 300 and future 301 periods may be updated dynamically according to the current time. In the specific example shown in FIG. 3a, the future event associated with the second time t2 is within future period 301.

The definition of the current 300 and future 301 periods allows, in the invention and as shown in FIG. 4, defining a first section 402 and second section 401 in the newsfeed of the user. In FIG. 4, for illustrative purposes the newsfeed is displayed on a user interface 400 (a screen) of the terminal 14 of the user. The first section 402 is dedicated to displaying events associated with times within the current period 300, and the second section 401 is dedicated to displaying events associated with times within the future period 301. Thus, the user can easily distinguish information resulting from instantaneous measurements, from information resulting from predictive measurements. The invention may allow for displaying expired events associated with times prior to the current period, in a third section not shown in FIG. 4.

The rest of the method for which the steps are illustrated with reference to FIG. 2 is now described.

In step 204, at least a second event notification indicating a second event associated with a third time t3 is received by the server 16, the third time t3 being between the first time t1 and the second time t2.

In step 205, the server 16 verifies that the second event is an event impacting the future event. For this purpose, it can check whether the second event is in the list of parameters events stored in association with the predictive model used to predict the future event.

In case of a positive verification, the future event is updated by the server according to the second event, in step 206.

The updated future event can then be displayed in the newsfeed in step 207.

FIGS. 3b-3e illustrates examples of updating the future event based on the second event.

Referring to FIG. 3b, the second event is an updated value measured by the first entity, in other words the humidity sensor 10 in the soil, at the third time t3. In this case, the second event directly impacts the future event because the second event is the input variable of the predictive model used to predict the future event. However, between time t1 and t3, it is possible that the user, aware of the future event, has anticipated the future event by watering the plant. In this case, the soil moisture content does not evolve as anticipated by the predictive model applied to the measurement of the moisture content at time t1, and updating the future event allows taking into account the watering by the user. The predictive model can thus be applied by taking as an input variable the moisture content measured by the sensor 10 at the third time t3. A fourth time t4 corresponding to the time when the moisture content reaches the moisture threshold value can thus be calculated. As the user has watered the plant, the fourth time t4 at which the soil moisture content reaches the moisture threshold value is later than the second time t2. In addition, when placed at the third time t3 (current time), the second time t2 and the fourth time t4 are both within the future period 301, and the updated future event is thus displayed in the second section 401 in association with the fourth time t4.

FIG. 3b is only provided for illustrative purposes. Indeed, it is possible for the updated value calculated by the first entity to be such that the fourth time t4 is later than the second time t2 (for example, in case of an unexpected rise in temperature, causing a rapid decrease in the soil moisture content).

Referring to FIG. 3c, the second event is a value measured by a second entity at the third time or an action implemented by a second entity at the third time. In the example represented, the second entity is the thermometer 11 and the measured value is therefore a temperature value at the third time 13. As explained above, the temperature is one of the parameters impacting the future event, and the verification implemented in step 205 is therefore successful. The predictive model applied to the moisture content measured at the first time t1 can then be modified by taking into account the temperature measured at the third time t3. The predictive model so updated is applied to the moisture content measured at the first time t1 in order to update the future event and calculate the fourth time t4. In the example illustrated in FIG. 3c, the temperature measured at time t3 is greater than the temperature used by default in the predictive model applied to the soil moisture content at the first time t1, and the fourth time t4 is prior to the second time t2 initially calculated. As illustrated in FIG. 3c, the future period 301 calculated at the third time t3 (current time) includes the second time t2, and the future event before the update was thus displayed in the second area 402 of the newsfeed. However, the fourth time t4 resulting from updating the future event is within the current period 300 calculated at the current time, and the updated future event is thus displayed in the first area 401 of the newsfeed in association with the fourth time t4. FIG. 3c is shown for illustrative purposes only: it will thus be understood that a temperature measured at time t3 that is below the temperature initially used by default in the predictive model would lead to obtaining a fourth time t4 later than the second time t2 (and in this case, the future event and the updated future event would both be displayed in the second area 402 of the newsfeed).

Referring to FIG. 3d, the second event is meteorological data such as temperature and/or moisture content of the air, coming from the weather station platform 17. The meteorological data may be an instantaneous measurement, such as the temperature and/or moisture content of the air at the third time t3 (current time), or may be a prediction of the temperature and/or moisture content of the air at a fifth time between the third time t3 and the second time t2. As explained above, the temperature and the moisture content of the air are parameters impacting the future event, and the verification implemented in step 205 is therefore successful. The predictive model applied to the moisture content measured at the first time t1 can thus be modified while taking into account the temperature and/or moisture content of the air measured at the third time t3 or predicted for the fifth time t5. The predictive model so updated is applied to the moisture content measured at the first time t1 in order to update the future event and calculate the fourth time t4. In the example illustrated in FIG. 3d, the measured or predicted temperature and/or measured or predicted moisture content of the air are such that the fourth time t4 is earlier than the second time t2 initially calculated. In addition, when positioned at the third time t3 (current time), the second time t2 and the fourth time t4 are both within the future period 301, the updated future event thus being displayed in the second section 401 of newsfeed in association with the fourth time t4.

Referring to FIG. 3e, the second event is a parameter defined by a user at the third time t3, for example via the application installed on the terminal 14. For example, the user can modify the predefined moisture threshold value from which the second time t2 was calculated. A second threshold value is thus defined by the user. Such a threshold value impacts the future event because time t2 is the exact moment at which the soil moisture content reaches the threshold value predefined in the predictive model. In the example illustrated in FIG. 3e, the threshold value is increased and thus the fourth time t4 is prior to the second time t2. As illustrated in FIG. 3e, the future period 301 calculated at the third time t3 (current time) comprises the second time t2 and the future event before updating is thus displayed in the second area 402 of the newsfeed. However, the fourth time t4 resulting from updating the future event is within the current period 300 calculated at the current time, and the updated future event is thus displayed in the first area 401 of the newsfeed in association with the fourth time t4. FIG. 3e is provided for illustrative purposes only: it is thus understood that increasing the moisture threshold value would lead to obtaining a fourth time t4 after the second time t2 (and in this case, the future event and the updated future event would both be displayed in the second area 402 of the newsfeed).

The method of the invention may further provide a step of detecting that the future event has expired (for example by detecting that the future event is within the current period 300), for the purpose of automated implementation of a corrective action by a third entity. In the example detailed above, the corrective action may be to trigger an automatic sprinkler when the future event has expired (when the preset or user-defined moisture threshold has been reached).

FIG. 5 shows the server 16 according to one embodiment of the invention.

The server 16 comprises random access memory 504 and a processor 503 for storing instructions to implement steps of the method described above. The device also comprises a database 505 for storing data to be retained after application of the method. The database 505 may include the storing of predictive models in association with the events impacting them, the default parameters used for the predictive models, and the parameters defined by the user. The server 16 also comprises an input interface 501 for receiving event notifications, and an output interface 506 for displaying events, future events, and updated future events on the user's newsfeed, under the control of the processor 503.

The server may further comprise a digital signal processor (DSP) 502.

The present invention is not limited to the embodiments described above as examples; it extends to other variants.

In addition, the provided examples involve three connected entities and a single access point. Such an architecture is given for illustrative purposes only and does not restrict the invention to these examples alone.

1. A method for managing a plurality of entities implemented in a server, each entity of the plurality of entities being able to send event notifications to the server, the server storing at least one predictive model for the prediction of future events, the method comprising the following operations:
receiving a first event notification from a first entity, the first event notification indicating a first event associated with a first time;
selecting a predictive model applicable to the first event;
deducing a future event associated with a second time that is later than the first time, by applying the determined predictive model to the first event, the future event being associated with at least one event impacting the future event;
displaying the future event in association with the second time, on a newsfeed; wherein, upon receiving at least a second event notification indicating a second event associated with a third time, the third time being between the first time and the second time, the method further comprising:
verifying whether the second event is an event impacting the future event;
in case of positive verification, updating the future event based on the second event; and
displaying the updated future event in the newsfeed.

2. The method according to claim 1, wherein the newsfeed is divided into a first section and a second section, the first section being dedicated to displaying events associated with times within a current period, and the second section being dedicated to displaying events associated with times within a future period.

3. The method according to claim 2, wherein the current period is updated dynamically.

4. The method according to claim 1, wherein the first event is a value measured by the first entity at the first time.

5. The method according to claim 4, wherein, a first threshold value being predefined, the second time is the moment at which the measured value reaches the predefined first threshold value after applying the predictive model to the value measured at the first time.

6. The method according to claim 4, wherein the second event is an updated value measured by the first entity at the third time, and wherein the future event is updated by applying the predictive model to the updated value measured at the third time.

7. The method according to claim 1, wherein the second event is a value measured by a second entity at the third time.

8. The method according to claim 1, wherein the second event is a parameter defined by a user at the third time.

9. The method according to claim 5, wherein the second event is the replacement by the user of the predefined first threshold value with a second threshold value, wherein the updating of the future event comprises determining a fourth time at which the measured value reaches the predetermined second threshold value after applying the predictive model to the value measured at the first time, and wherein the updated future event is displayed in association with the fourth time on the newsfeed.

10. The method according to claim 1, wherein the second event is a prediction made at the third time of a second future event at a fifth time, the fifth time being between the fourth time and the second time.

11. A non-transitory computer-readable medium having a program stored thereon, the program comprising instructions for implementing the method according to claim 1, when these instructions are executed by a processor.

12. A server for managing a plurality of entities, each entity of the plurality of entities being able to send event notifications, the server comprising a unit for storing at least one predictive model for the prediction of future events, a reception interface for receiving a first event notification from a first electronic entity, the first event notification indicating a first event associated with a first time, and a processor arranged to implement the following operations:
selecting a predictive model applicable to the first event;
deducing a future event associated with a second time that is later than the first time, by applying the determined predictive model to the first event, the future event being associated with at least one event impacting the future event;
displaying the future event in association with the second time, on a newsfeed; wherein, upon receipt by the reception interface of at least a second event notification indicating a second event associated with a third time, the third time being between the first time and the second time, the processor is further arranged to implement the following operations:
verifying that the second event is an event impacting the future event; and
in case of positive verification, updating the future event based on the second event; displaying the updated future event in the newsfeed.
